(19) United States
(12) Patent Application Publication
(10) Pub. No.: US 2023/0372176 A1
(43) Pub. Date: Nov. 23, 2023

(54) DEVICE FOR SUPPORTING A HUMAN BODY IN A LYING POSITION

(71) Applicant: COMPAGNIE GENERALE DES ETABLISSEMENTS MICHELIN, Clermont-Ferrand (FR)

(72) Inventors: BERTRAND DAVAL, Clermont-Ferrand (FR); CHRISTOPHE LE CLERC, Clermont-Ferrand (FR); MATHIEU GIRARD, Clermont-Ferrand (FR); THOMAS GUY, Clermont-Ferrand (FR); PHILIPPE JACQUIN, Clermont-Ferrand (FR); GILLES TOUATI, Amiens (FR)

(21) Appl. No.: 18/031,434

(22) PCT Filed: Oct. 8, 2021
(86) PCT No.: PCT/FR2021/051751

§ 371 Date: Apr. 12, 2023

(30) Foreign Application Priority Data
Oct. 12, 2020 (FR) FR2010418

(51) Int. Cl. A61G 13/12

(52) U.S. Cl. CPC A61G 13/1215; A61G 13/1255; A61G 13/123; A61G 13/1265; A61G 13/1285; A61G 13/122; A61G 2200/322; A61G 2200/325

(57) ABSTRACT

A device for supporting a human body in a lying-down position, notably in a prone position, is made up of at least one shoulder support module and at least one pelvis support module. The shoulder support module and the pelvis support module are made up of a first portion that comes into contact with the human body, the first portions forming a pneumatic cavity having a valve, and the first portion of the shoulder support module being kept at a pressure of less than 0.04 bar underneath the weight of the human body.

The present invention relates to a device for supporting a human body in a lying-down and stationary position. Although it is not limited to this type of application, the invention will be described more particularly with reference to patients in a hospital environment and more particularly in a resuscitation unit, the patients being in a prone position and deep in an artificial coma.

In numerous situations, hospitalized patients, whether they are in a room or else in the operating theatre, must remain lying down without moving. Irrespective of the quality of the mattress, the pressure exerted by the weight of the patient between the bones and the areas where the mattress bears against the skin and the flesh appears to lead to necrosis or bedsores.

Such unpleasantness is effectively observed after surgery lasting several hours when the patient must be kept in a position with some bearing points. This unpleasantness can also appear in patients who are hospitalized for long periods of time.

It is an even more critical case for patients placed in a resuscitation unit for acute respiratory stress syndrome (SDRA). This is the case, for example, for patients suffering from a viral infection leading to respiratory complications. This case is notably known for coronavirus infections, such as COVID-19.

A known technique for improving the condition of a patient already being given respiratory assistance is to put them in a prone position, which corresponds to a position of lying on the stomach. This position makes it possible to assist the expansion of the lungs more than a position of lying on the back does. The patient is then in an artificial coma state and must remain in this position for several hours, the manoeuvre being regularly repeated.

Patients undergoing this type of situation are moreover very often overweight, or even obese, this type of individual being most susceptible to the infection progressing to respiratory failure. This is the case for persons weighing more than 150 kg.

An unconscious body that is insensitive to pain due to the artificial coma with which an overweight condition is associated is particularly likely to have severe bedsores appear.

The technique currently used in hospitals to put the patient into a prone position consists in the placement of wedges to raise up the patient and clear their thoracic cage in order to allow it to breathe. The wedges are very often foam or gel objects and are supplemented by the spontaneous fabrication of rolled sheets so as to free up passages for the various connections necessary for the survival of the patient. These connections are necessary, for example, for the respiratory assistance that the patient receives. They also involve various catheters for perfusion or various probes or else electrodes for monitoring the data of the patient.

These devices have proven to lead to frequently significant bedsores because of the pressures exerted on the skin and the flesh and make it very complicated to access the various connections.

U.S. Pat. No. 6,047,420 describes a system for supporting the head and the chest, the parts of which that come into contact with the skin being flexible.

Patent application DE 10 2009 004 604 describes a wedge assembly for supporting a body in a prone position.

Patent application CN 109498317 describes a another system for supporting a body in a prone position.

These various systems make it possible, a priori, to give the patient a raised up position so as to allow the patient's lungs to work freely, but they are not designed for such positioning over a lengthy period of time, this running the risk of causing bedsores on the patient.

The inventors thus set themselves the object of proposing a device permitting a hospitalized patient to lay down and be stationary for a lengthy period of time, which limits the risk of bedsores appearing and allows access to all the areas of the body that require a connection via catheters, probes, electrodes or other devices useful in the care of the patient.

This aim has been achieved according to the invention by a Device for supporting a human body in a lying-down position, made up of at least one shoulder support module and at least one pelvis support module, the said at least one shoulder support module and the said at least one pelvis support module being made up of at least one first portion that comes into contact with the human body, the said at least one first portion each forming a pneumatic cavity, the said at least one first portion having a valve, and the said at least one first portion of at least one shoulder support module being kept at a pressure of less than 0.04 bar underneath the weight of the human body.

Advantageously according to the invention, the device has at least one head support module, the said at least one head support module being made up of at least one first portion that comes into contact with the human body, the said at least one first portion forming a pneumatic cavity, the said at least one first portion of the said at least one head support module having a valve, and at least the said first portion being kept at a pressure of less than 0.04 bar underneath the weight of the human body.

More advantageously still according to the invention, the device has at least one leg support module, the said at least one leg support module being made up of at least one first portion that comes into contact with the human body, the said at least one first portion forming a pneumatic cavity, the said at least one first portion of the said at least one leg support module having a valve, and at least the said first portion being kept at a pressure of less than 0.04 bar underneath the weight of the human body.

Preferably according to the invention, at least one first portion of at least one support module for a part of the human body, and more preferably still at least one of the first portions of the head support, shoulder support and/or leg support modules, are kept at a pressure of less than or equal to 0.03 bar underneath the weight of the human body.

According to a preferred embodiment of the invention, at least one first portion of at least one support module for a part of the human body, and more preferably still at least one of the first portions of the head support, shoulder support, pelvis support and/or leg support modules, is made up of at least one sheet of thermoplastic polymer preferably exhibiting a modulus of elasticity under tension at 10% elongation of less than 50 MPa.

The measurements of the moduli of elasticity under tension at 10% elongation are taken in accordance with the standard DIN 53504.

Preferably, the sheet of thermoplastic polymer exhibits a modulus of elasticity under tension at 10% elongation of less than 25 MPa.

More preferably still, the sheet of thermoplastic polymer has a thickness of less than 1 mm and even more preferably less than 0.5 mm.

Such a material, in a known manner, enables the simple production of an element having a sealed cavity that can be pressurized. A particularly suitable material is a thermoplastic polyurethane. It is possible to realize heat sealing by locally bringing the sheet to its melting temperature. The stiffness properties of the sheet will make it possible to contribute to reducing the risks of bedsores when it is in contact with the skin.

Advantageously according to this preferred embodiment of the invention, at least one support module for a part of the human body, and more preferably still at least one of the first portions of the head support, shoulder support, pelvis support and/or leg support modules, is made up of at least two sheets of thermoplastic polymer, at least one of the sheets of thermoplastic polymer being reinforced. This reinforcement may be on the basis of fibres or fabric and leads to a sheet of thermoplastic polymer that is stiffer than one exhibiting a modulus of elasticity under tension at 10% elongation of less than 50 MPa and that advantageously will not come into contact with the skin of the patient.

Advantageously according to the invention, at least one support module for a part of the human body has a second portion supporting the first portion, the second portion preferably being made up of a deformable structure and preferably having means for stabilizing the first portion.

The deformable nature of the structure making up the second portion of at least one support module for a part of the human body contributes to the comfort of the patient and to reducing the risk of bedsores appearing.

According to the invention, at least one first portion of at least one support module for a part of the human body and more advantageously still, the first portion of the head support, shoulder support, pelvis support and leg support modules have a valve which makes it possible to maintain the required pressure under the effect of the weight of the human body, and to possibly control the pressure when the device is being used.

The valve is advantageously positioned so that it is made accessible during use and cannot come into contact with the human body.

More advantageously still, the valve is a gate valve to best ensure leaktightness.

The inflation pressure of the pneumatic cavities of all of the modules is advantageously greater than 0.005 bar underneath the weight of the human body.

At least one first portion of at least one support module for a part of the human body and notably the first portion of the head support, shoulder support, pelvis support and leg support modules is advantageously inflated with an inert and/or purified gas to avoid any risk of additional infection in the event of an accident in relation to one of the modules that leads to a leak.

According to a preferred embodiment of the invention, the shape of at least one support module for a part of the human body and preferably the respective shapes of the said at least one shoulder support, pelvis support and leg support modules each have an axis of symmetry substantially parallel to the axis of symmetry ranging from the feet to the head of the body that is supported. The modules, being provided to support a body which is substantially symmetrical, are advantageously produced with a symmetrical overall shape in order to support the body as uniformly as possible so as to best distribute the load and ensure the stability of the body in the position defined by the medical staff.

More preferably still according to the invention, the second portion of at least one support module for a part of the human body and advantageously the second portion of at least one of the head support, shoulder support and/or pelvis support modules is made up of multiple stackable elements. Making a second portion from multiple elements makes it possible first of all to be able to modify the volume and the height of this second portion so as to enable simple adaptation of the device to the height or build of the human body that must be supported, or more simply to a type of position; if it is necessary to raise up the body for some reason, all that needs to be done is to add one or more elements to obtain the desired dimension. Lastly, this adaptation of the volume can be done with elements of simple shape, these being essentially added to modify the height of the module in question, only the element that comes into contact with the first portion having a particular shape in order to perform its functions when connected to the first portion and the human body.

According to a particularly advantageous embodiment of the invention, the human body is in a prone position, that is to say in a position in which the body is substantially lying down on the stomach.

The device for supporting a human body in a lying-down position thus described according to the invention makes it possible to support a body in a desired position with a reduction in the risk of bedsores appearing in the areas of contact with the support modules and all the areas of the body that require connections or attachment to respiratory assistance systems remain accessible.

Specifically, the inventors have demonstrated that the maintenance of the first portions of the support modules at the chosen pressures underneath the weight of the human body, the said portions being advantageously made up of at least one sheet of thermoplastic polymer exhibiting a modulus of elasticity under tension at 10% elongation of less than 50 MPa, and preferably less than 25 MPa, reduces the risk of bedsores appearing, the said first portions being produced accurately in order to bear against the human body at the desired locations. The presence of at least one shoulder support and at least one pelvis support with the accuracy of the bearing points obtained furthermore makes it possible, in the case of a prone position, for the individual to breathe by freeing up the movable parts of their thorax and abdomen whilst still protecting notably their genitals.

Producing these first portions of the support modules fora part of the human body from heat sealable material moreover makes it possible to produce the shape in a simple way, as mentioned above, and relatively accurately. Irrespective of the support module for a part of the human body, heat sealing will make it possible to define the shape of the portion of the support module that comes into contact with the body with such accuracy that the support module can bear optimally against the human body. Specifically, the inventors have demonstrated that they could obtain shapes that bear against the maximum areas on the human body by allowing, for the one part, the lungs to work and, for the other part, various connections to be passed through, and thus ensure the support of the human body at the indicated pressures of less than 0.04 bar underneath the weight of the body, for certain support modules. The inventors have also shown that, at such pressures, it was possible to support a human body for periods of time notably suitable for the prone position to treat respiratory problems without seeing the appearance of necroses or bedsores that are difficult to treat.

Furthermore, when certain support modules are produced in at least two portions, it is advantageously possible to separate out the functions. For the one part, the second portions provide the volume necessary to position the human body as desired and the stiffness to ensure stability. For the other part, the first portions with reduced volume can be easily kept at the selected pressures and produced even more accurately to bear against the human body at the desired locations.

The second portions are still provided with means for stabilizing the first portions in the desired positions and thus make it possible for the one part to ensure the desired bearing points and for the other part to ensure the stability of these bearing points. These means can be directly linked to the shape of the second portions, which can be provided to receive the first portions and prevent them from moving, notably in the presence of the human body. It is still possible to provide hook systems between the first and second portions; this may involve, for example, mechanical fixing systems with textile hooks and loops, sold under the trade name “Velcro”, which are simple to use and enable adjustable positioning.

The thinking of the inventors is thus to propose a device which is entirely suitable for supporting a human body, notably in a prone position, with reduction of the risks linked to the appearance of bedsores, which moreover can be realized with entirely acceptable costs. These low costs also permit the availability of modules of different heights or shapes for better adaptation to the height and volume of the human body. This selection of the height of the modules also makes it possible to optimize the positioning of the bearing points on the human body against these modules.

It should also be noted that, notably in the event of respiratory problems, since the use of the device according to the invention makes it possible to reduce the secondary effects of the prone position, notably bedsores, it is possible to lengthen the treatment time in this position and thus to shorten the overall treatment time for successful healing of the patient. The thus reduced treatment time also reduces the risk of bedsores appearing.

According to a first embodiment variant of the invention, the second portion of at least one support module for a part of the human body is at least partially made up of a polymer foam with a compressive stiffness of between 5 KPa and 50 KPa.

The compressive stiffness is measured in accordance with the standard ISO 3386/1.

According to a second embodiment variant of the invention, the second portion of at least one support module for a part of the human body is at least partially made up of a pneumatic cavity, the said second portion of the said at least one support module for a part of the human body having a valve, the said second portion of the said at least one support module for a part of the human body being kept at a pressure of between 0.05 and 1 bar underneath the weight of the human body.

According to other embodiment variants of the invention, the second portion of at least one support module for a part of the human body may have a pneumatic portion, which preferably does not come into contact with the first portion. It may, for example, be one of the stackable elements described above. Such a variant can make it possible to create a larger volume after the placement of the human body and thus facilitate this placement, the pneumatic portion still not being inflated when the human body is positioned and the volume of the second portion thus being reduced in comparison with its volume during use. When it is present, this pneumatic portion that makes up the second portion is preferably kept at a pressure of between 0.05 and 1 bar underneath the weight of the human body.

Advantageously according to the invention, at least the areas of at least one first portion of at least one support module for a part of the human body, and preferably at least one of the areas of the first portions of each of the head support, shoulder support, pelvis support and/or leg support modules, that are intended to come into contact with the skin are covered with a medical fabric.

Within the meaning of the invention, a medical fabric is a fabric which is commonly used in a hospital environment and is suitable for coming into contact with the skin of the patient and therefore is considered to be non-irritant, to not carry possible sources of infection, and to be easily cleanable with the products used in a hospital environment.

Since it is in contact with the human body for a lengthy period of time, these fabrics can also be three-dimensional fabrics of the “XD Spacer Fabric” type sold by the company Baltex, which are already used in medical applications. These three-dimensional fabrics have the advantage of ensuring the surface of the skin of the human body in contact with the support module is ventilated.

These fabrics are advantageously provided as removable so as to be able to be correctly cleaned and/or changed regularly.

It is also possible to provide a cover made from the medical fabric that envelops all of the first portion of the module forming the pneumatic cavity and is intended to come into contact with the human body, or else a cover enveloping the entirety of the support module. In all cases, these covers are provided as removable so as to be correctly cleaned and/or changed regularly. In the case of a cover which envelops the first and second portions of a support module, the cover advantageously contributes to stabilizing the two portions together.

According to a preferred embodiment of the invention, the head support module supports a lateral side of the head, the position of the head being oriented laterally as if the person were looking to the side.

Notably in the case of the prone position, it has proven preferable to be able to access the patient laterally so as to make it possible to provide them with ventilation by intubation.

More preferably still, the head support module is profiled to act as a bearing point for one side of the head and a cutout is provided so as to leave the ear accessible and free from bearing stresses. The profile is thus advantageously defined to bear against certain bones of the skull, such as the lateral part of the forehead, the area around the ear and the jaws, thus leaving the eyes, the mouth, the nostrils and the ear free either so that respiration assistance devices can access them or because they are too sensitive to pressure.

The head support module and preferably the second portion also advantageously has movement prevention areas forming wedges at the forehead and the chin for a good hold, the head having a natural rotational movement that returns it to a position of muscular relaxation.

The support device for a human body in a lying-down position preferably has an additional head support module similar to the preceding one, which is its mirror image in order to be suitable for supporting the other side of the head. The device thus advantageously has a right-hand head support module and a left-hand head support module. The support of the human body notably in a prone position with the head being held in a lateral position is preferably accompanied by turning the head by approximately 180° at regular intervals in order to avoid any risk to the muscles; such an operation requires a head support module for each side and therefore two different modules.

The first portion of the one or more head support modules is advantageously made up of two sheets of thermoplastic polymer that are heat sealed over their periphery after having been cut to the desired shape, the second portion being provided with a similar shape in order to receive the first portion. Heat sealing also makes it possible to create the cutout for the ear.

A first portion produced in this way resembles an air bag, or even a buoy, because of the cutout for the ear, with a particular shape.

According to a preferred embodiment of the invention, the shoulder support module has an asymmetry between the portion oriented towards the lower body and the portion oriented towards the head so as to optimize the support of the fixed parts of the body surrounding the thorax during breathing.

The shoulder support module is thus advantageously designed to bear against the fixed parts of the thoracic cage, these being the base of the shoulders, the collarbones and the fixed ribs, leaving the movement of the neck, the floating ribs and the abdomen free to enable the patient to breathe.

As in the case of the head support module, the first portion of the shoulder support module is advantageously made up of two sheets of thermoplastic polymer that are heat sealed over their periphery after having been cut to the desired shape, the second portion being provided with a similar shape in order to receive the first portion. The first portion formed in this way has a shape similar to that of a cushion.

Making this shoulder support module asymmetric between the portion oriented towards the lower body and the portion oriented towards the head thus optimizes the bearing support against the fixed areas of the human body during breathing. In order to best free up the abdomen whilst still maintaining this optimized bearing against the fixed areas, the portion oriented towards the lower body advantageously has a heat sealed area in its central part to locally eliminate the pneumatic cavity and make it possible to reduce, or even eliminate, bearing against the area of the sternum. The first portion is advantageously heat sealed in its central portion whilst still making it possible to maintain a single pneumatic cavity in order to maintain a uniform pressure.

According to one embodiment variant, the shoulder support module may be made in two separate portions, it then being transformed into two separate modules, to completely free up the central part of the human body. This variant has advantages, notably for the connection of electrodes, but can become awkward when the body is being placed, notably when the body is overweight, in terms of ensuring proper positioning and the desired distribution of the bearing points.

According to a preferred embodiment of the invention, the first portion of the pelvis support module comprises a sheet of thermoplastic polymer that is heat sealed over the length of two ends to form a tube and the central portion of the said first portion of the pelvis support module is partially heat sealed so as to form a non-pneumatic area.

The first portion of the pelvis support module is thus designed to bear against the iliac crests and a weak area of the lower abdomen, while preventing any contact with the genitals and leaving the inguinal regions and the tops of the thighs free to enable the various connections of probes or other catheters.

The first portion of the pelvis support module is thus advantageously produced with a tubular shape, of which the ends can be heat sealed to form a shape of sachet type or else each of the ends of the tube can be closed by an additional heat sealed sheet to close off the said end. Outside of the central portion of the tube having a heat sealed portion, the cross section of the tube may be provided with a different shape, or the tube may even have a variable cross section over its length, for example to form two frustoconical parts on either side of the central portion.

Produced in this way, the first portion of the pelvis support module is positioned on a second portion, which is the bulkiest one compared to the other modules and is provided to raise up the human body so as to enable breathing. This second portion of the pelvis module will be all the bulkier if the patient exhibits signs of obesity. This second portion is also advantageously provided with a V shape having a relatively flat area between two inclined arms, the flat area being provided to receive the central portion of the first portion. This V shape makes it possible for the one part to properly position and centre the human body and for the other part to ensure the bearing of the pelvis against the iliac crests while avoiding contact with the genitals, which remain below and remote from the flat area at the base of the V.

As in the case of the first portion of the shoulder support module, the first portion of the pelvis support module is advantageously heat sealed in its central part to avoid pressure being exerted on the genitals whilst still making it possible to retain a single pneumatic cavity in order to maintain a uniform pressure.

According to one embodiment variant, the pelvis support module may be made in two separate portions, it then being transformed into two separate modules, to completely free up the central part of the human body. As in the case of the first portion of the shoulder support module, this variant can become awkward when the body is being placed, notably when the body is overweight, in terms of ensuring proper positioning and the desired distribution of the bearing points.

Preferably according to the invention, the one or more first portions of the pelvis support module are kept at a pressure of between 0.01 and 0.1 bar underneath the weight of the human body. Such pressures can be necessary because of the small bearing surface against the body that is obtained for this pelvis support module.

According to a preferred embodiment of the invention, the leg support module comprises a sheet of thermoplastic polymer that is heat sealed over the length of two ends to form a tube.

As in the case of the first portion of the pelvis support module, the ends can be heat sealed to form a shape of sachet type or else each of the ends of the tube can be closed by an additional heat sealed sheet to close off the said end.

The leg support module is provided to bear against the shins and the positional accuracy is not important, this making it possible to dispense with a second portion, all the more so because in principle this part of the body does not need to be raised up to enable breathing. The essential function of this leg support module is to avoid contact between the toes and the bed or other support on which the device is installed. For that, leg support modules of various diameters are advantageously provided.

However, according to one embodiment variant of the invention, the leg support module is provided with a second portion. This variant may be necessary if a patient has a very large build for which the pelvis support module is raised up to a great extent to keep the body in a substantially lying-down position.

According to other variants of the invention, the device may comprise complementary knee support modules, although the knees are less sensitive to the risks of bedsores. This may be a single module or two independent modules.

Whether it is a single module or two, they can be made up solely of a pneumatic cavity advantageously kept at least at 0.04 bar underneath the weight of the human body.

Preferably, notably in the case of two knee support modules, they are each made up of two sheets of thermoplastic polymer that are heat sealed over their periphery and initially precut to the desired shape. It is thus possible to form two first portions resembling cushions, or buoys if a central cutout is provided.

As in the case of the leg support module, according to one embodiment variant of the invention, the one or more knee support modules are provided with a second portion. This variant may be necessary if a patient has a very large build for which the pelvis support module is raised up to a great extent to keep the body in a substantially lying-down position.

According to other embodiment variants of the invention, one, more or all of the modules are placed on a highly stiff sheet to make the support device more stable.

Such sheets are, for example, sheets that are already used in hospitals and sold under the trade name “KOMACEL”.

The invention as has just been described, in addition to its advantages as regards the reduction in the risk of bedsores appearing, has numerous advantages notably linked to the inflatable nature of the portions making up the support modules. This is because, for the one part, the use of inflatable elements makes it possible to reduce their volumes when not in use or before use and thus facilitate their storage. In connection with this decrease in volume, it becomes possible to store a significant number and variety of these elements and thus to have available the model which is best suited to the situation, notably in terms of shape variety, at any time. For the other part, when the two portions that make up the support modules are also inflatable elements, in addition to the advantages mentioned it becomes possible for operators to reduce the volume of these second portions, one of the functions of which is notably to provide volume, and thus to facilitate handling of the human body. This is particularly important for patients placed in a prone position who need to be regularly placed on the back; the reduction in the volume of the bulkiest portions makes it possible to facilitate such operations.

The invention also proposes a method for supporting a human body implementing the device as has just been described, in which method, in a first step, the cavity of at least one first portion of at least one support module for a part of the human body is partially filled with air, in a second step, the human body is disposed on the said at least one support module for a part of the human body and, in a third step, the pressure of the said cavity of at least one first portion of at least one support module for a part of the human body is regulated to a pressure less than 0.04 bar.

According to a variant of the method for supporting a human body of the invention, with at least one support module for the human body having a second portion supporting a first portion of the said support module for the human body and at least partially forming a pneumatic cavity, in a fourth step, the pressure of the said cavity of the second portion of the said support module for the human body is regulated to a pressure of between 0.05 and 1 bar.

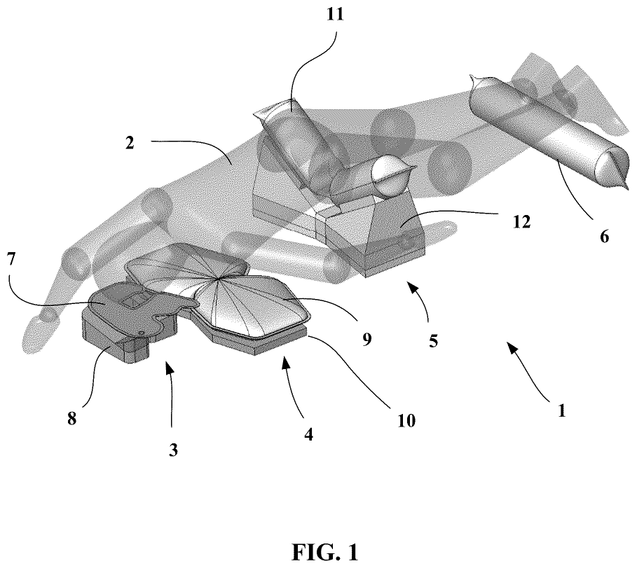

Further details and advantageous features of the invention will become apparent from the following description of exemplary embodiments of the invention, with reference to FIGS. 1 to 12, in which:

FIG. 1 shows an overall schematic view of a human body resting in a prone position on a support device according to the invention,

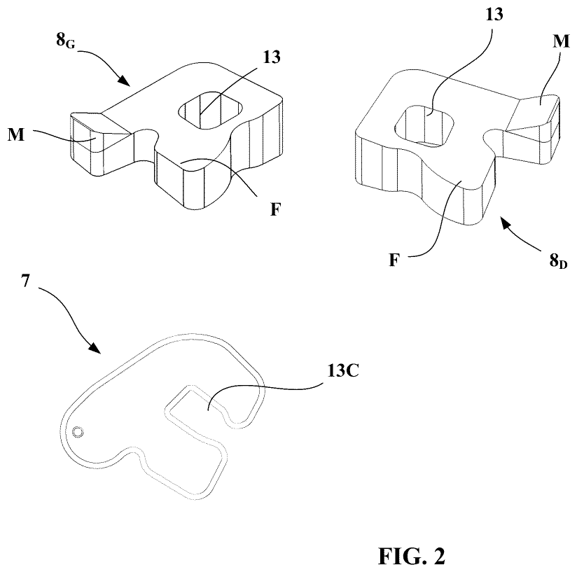

FIG. 2 shows a schematic depiction, in perspective, of two head support modules,

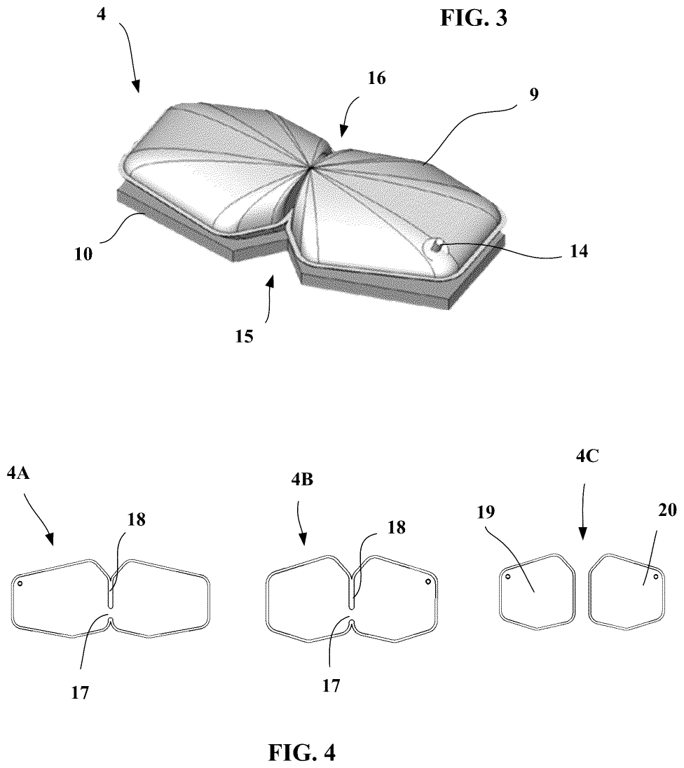

FIG. 3 shows a schematic depiction, in perspective, of a shoulder support module,

FIG. 4 shows a schematic depiction of three embodiment variants of a shoulder module,

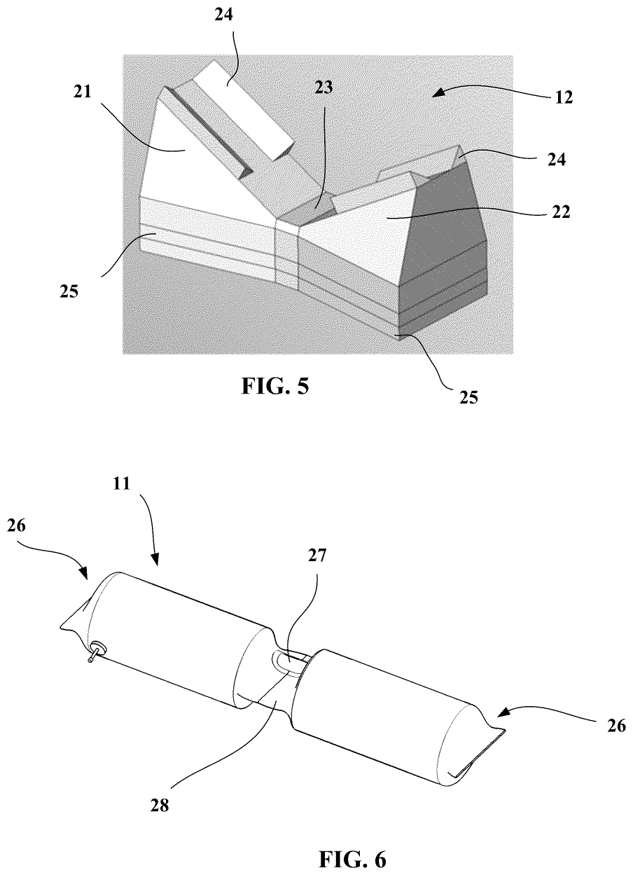

FIG. 5 shows a schematic depiction, in perspective, of the second portion of a pelvis support module,

FIG. 6 shows a schematic depiction, in perspective, of a first portion of a pelvis support module,

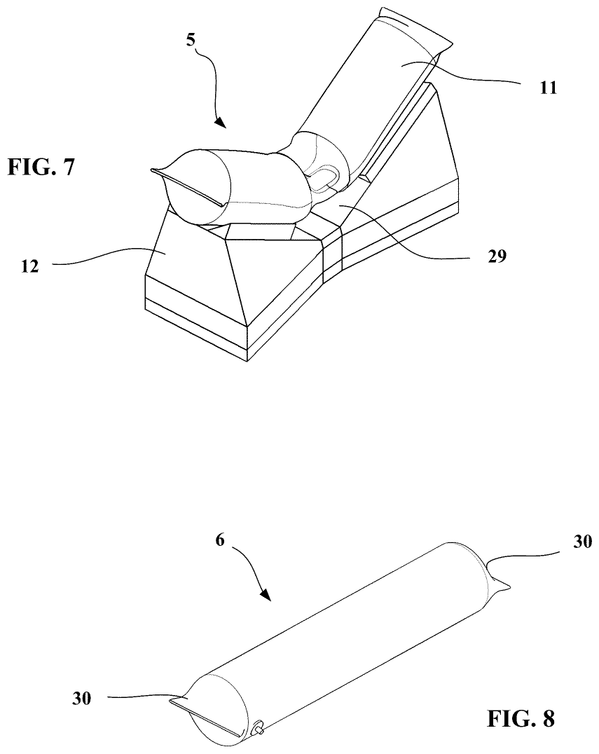

FIG. 7, shows a schematic depiction, in perspective, of a pelvis support module combining the first and second portions of FIGS. 5 and 6,

FIG. 8 shows a schematic depiction, in perspective, of a leg support module,

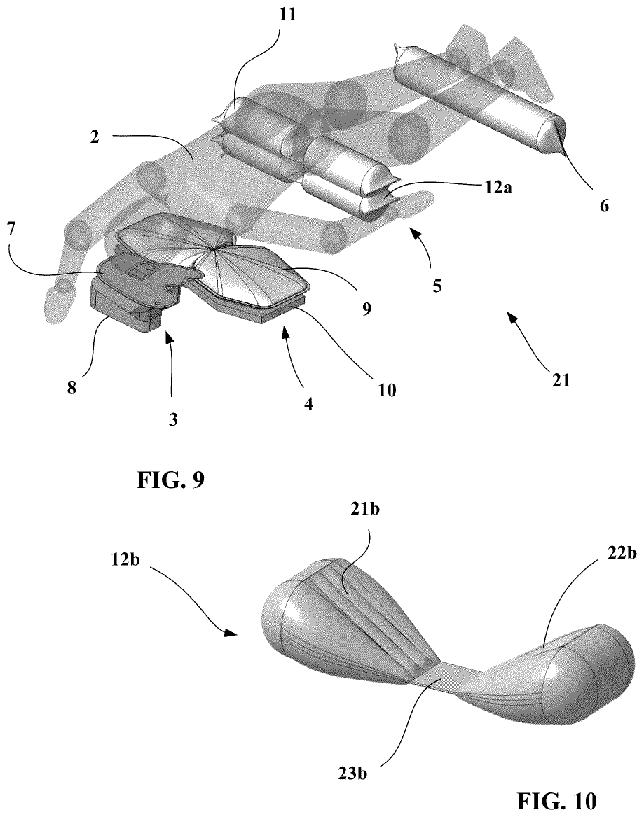

FIG. 9 shows an overall schematic view of a human body resting in a prone position on a support device according to one embodiment variant of the invention,

FIG. 10 shows a schematic depiction, in perspective, of the second portion of a pelvis support module according to a particular embodiment of the embodiment variant presented in FIG. 9,

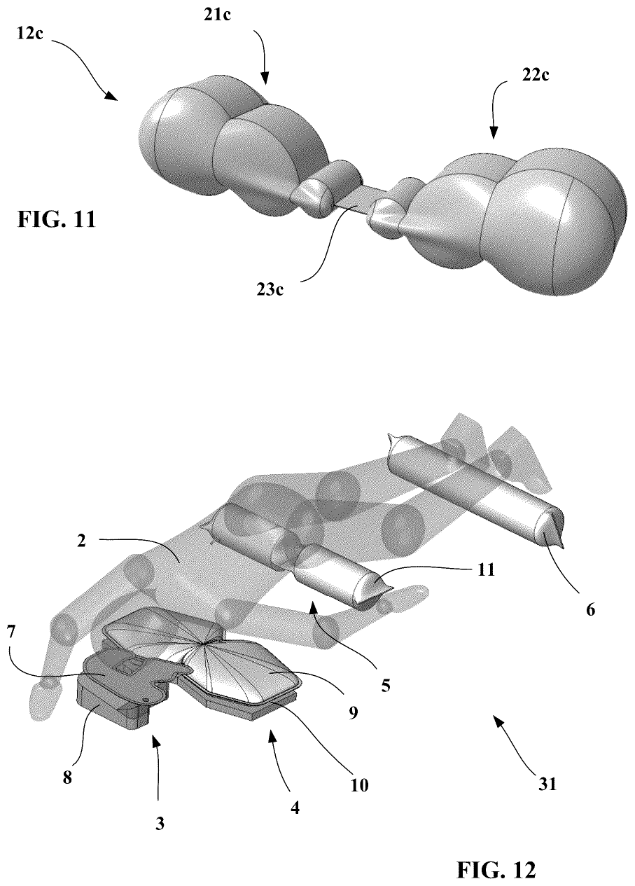

FIG. 11 shows a schematic depiction, in perspective, of the second portion of a pelvis support module according to another particular embodiment of the embodiment variant presented in FIG. 9,

FIG. 12 shows an overall schematic view of a human body resting in a prone position on a support device according to another embodiment variant of the invention.

In order to make them easier to understand, the figures have not been drawn to scale.

FIG. 1 schematically shows the support device 1 for a human body 2 with its four support modules 3, 4, 5 and 6.

The head support module 3 is made up of a first portion 7 forming a pneumatic cavity in the form of a cushion or buoy. This first portion 7 is supported by a second portion 8.

The shoulder support module 4 is made up of a first portion 9 forming a pneumatic cavity in the form of a cushion. This first portion 9 is supported by a second portion 10.

The pelvis support module 5 is made up of a first portion 11 forming a pneumatic cavity in the form of a tube or bead folded in its centre. This first portion 11 is supported by a second, V-shaped portion 12.

The leg support module 6 is made up of a tube forming a pneumatic cavity on which the shins of the human body 2 rest.

The first portions 7, 9, 11 and the leg support module 6 are made from sheets of thermoplastic polyurethane sold under the name Tuftane TFL-1E exhibiting a secant modulus of elongation equal to 9.8 MPa at 10% elongation.

The second portions 8, 10, 12 are produced from a foam sold by the company Recticel under the trade name “Situseal” with the reference T 46065, exhibiting a compressive stiffness of between 8 and 12 KPa.

The patient thus supported by the device 1 in a prone position is fully accessible to realize the necessary connections in terms of catheters and electrodes, and the lateral position of their head easily permits respiratory assistance to be given to them. The device 1 moreover makes it possible to make breathing easier, since the movable parts of their thoracic cage and abdomen are free to move for breathing purposes.

FIG. 2 first of all schematically illustrates, in perspective, two second portions 8_{D} and 8_{G} of the head support module 3, one being intended to support the right-hand lateral part of the head and the other the left-hand lateral part of the head.

The second portion 8_{D}, intended to support the right-hand lateral portion of the head, has a cutout 13 to let the ear through and not crush it. The second portion 8_{D} is designed to best support the head and distribute the bearing points over part of the forehead, around the ear, and the jaws.

The portions F and M of the second portion 8_{D}, intended to support the forehead and the chin, respectively, are provided with an overthickness to form the wedges and prevent the natural rotation of the head in returning to a position facing the ground.

The second portion 8_{G}, which is intended to support the left-hand lateral part of the head, is produced as identical to the portion 8_{D}, but symmetrically.

These two second portions 8_{D} and 8_{G} of the head support 3 are alternatively used to support the head of the patient, it being necessary that the head is not held in a lateral position for excessively lengthy periods of time on one and the same side.

FIG. 2 also illustrates the first portion 7 of the head support module 3. Its shape is similar to the second portions 8_{D} and 8_{G} so that it can be stacked on them and, in the same way, it has a cutout 13C to let the ear through and not crush it. This first portion 7 that forms a pneumatic cavity with the shape of a cushion or buoy can be used with the two second portions 8_{D} and 8_{G} provided that the two sheets of thermoplastic polyurethane used are indeed intended to come into contact with the skin.

FIG. 3 schematically shows, in perspective, a shoulder support module 4 made up of a first portion 9 forming a pneumatic cavity in the form of a cushion and a second portion 10 supporting the first portion 9. In this FIG. 3, the reference 15 indicates a flare for limiting the extent of bearing against the top part of the abdomen and the sternum to enable breathing. The reference 16 indicates a flare for limiting the extent of bearing against the neck and the windpipe.

It is also possible to observe that the shoulder support module 4 has an asymmetry between the portion oriented towards the flared area 15 and the portion oriented towards the flared area 16. The areas surrounding the flared portion 16 are designed to bear against the shoulders and free up the neck.

FIG. 4 shows three embodiments of this shoulder support module 4.

The shoulder support module 4A has a relatively elongate shape and will be particularly suitable for a person with a very large build. The shoulder support module 4B has a shape relatively similar to that of the module 4A and will be particularly suitable for a person with a smaller build.

In these two depictions, it is possible to observe an area 17 which indicates a passage for the inflation gases, whereas the area 18 indicates a heat sealed portion. This area 18 is intended to limit the extent of bearing against the sternum and the area 17 makes it possible to equalize the pressure exerted on the body 2.

The last embodiment of the shoulder support module 4C corresponds to an embodiment in two symmetrical portions 19 and 20. As mentioned above, such an embodiment can enable facilitated access for certain connections of the electrode type for an electrocardiogram. By contrast, the placement of the human body 2 on these modules is awkward and makes uniform distribution of the bearing points more complex.

FIG. 5 shows, in perspective, the second portion 12 of the pelvis support module 5. This second portion 12, in its upper portion intended to receive the first portion 11, has a V shape forming two arms 21 and 22 separated from one another by a flat base 23. Each of the arms 21 and 22 has wedges 24 that are provided to wedge the first portion 11.

Provided underneath this V shape are multiple additional elements 25 for adjusting the height and the volume of this second portion 12. The number of additional elements 25 will be adapted depending on the build of the human body 2.

As explained above, the second portions 8 and 10 of the head support module 3 and shoulder support module 4 may also have additional elements for adapting the height of the said second portions 8 and 10.

FIG. 6 shows, in perspective, the first portion 11 of the pelvis support module 5. This first portion 11 forms a cylindrical tube which has been closed at its two ends 26 by heat sealing. This embodiment makes it possible to produce the cylinder by heat sealing a sheet of thermoplastic polyurethane, the sealing being performed on the inside of the cylinder. In this way, no noticeable seal comes into contact with the human body. In its central portion, the first portion 11 retains a passage area 27 for ensuring equalization of the pressures and an area 28 is flattened by suitable heat sealing to obtain the desired shape.

The combination of this area 28 of the first portion 11 with the area 23 of the second portion 12 will make it possible to centre the portion 11 on the portion 12, as illustrated in FIG. 7, and especially create an area 29 that is not in contact with the human body 2 in order to protect its genital areas and avoid any contact and bearing at this level of the body 2.

FIG. 8 illustrates one embodiment of the leg support module 6. It is made up of a cylindrical pneumatic cavity closed at its two ends 30.

The cylinder is produced as for the first portion 11 of the pelvis support module 5. The ends 30 of the cylinder are then heat sealed to give the appearance of a sachet shape.

FIG. 9 schematically illustrates an embodiment variant of a support device 21 for a human body (2) in a prone position.

This device 21 differs from the device 1 of FIG. 1 in terms of the pelvis support module 5. According to this embodiment variant, the second portion 12a is an inflatable element produced in a similar way to the first portion 11. By contrast, its pressure underneath the weight of the human body during use will be greater than that of the first portion and be between 0.05 and 1 bar.

According to a preferred embodiment variant of the invention, illustrated in FIG. 10, in such an embodiment according to which the second portion of the pelvis support module is an inflatable element, this second portion 12b is designed to have a shape similar to the second portion 12 shown in FIG. 1 once it is maintained under pressure underneath the weight of the human body. FIG. 10 thus describes a second portion 12b having a V shape with two arms 21b and 22b that are separated by a flattened area 23b. Such an inflatable element 12b can be produced easily with sheets of thermoplastic polyurethane by heat sealing the sheets and adding heat sealed sheets of thermoplastic polyurethane to each of the arms 21b and 22b so as to form internal walls in the cavity of each of the arms to obtain relatively flat surfaces for receiving the first portion 11 of the pelvis support. These heat sealed walls are put in place before each of the arms 21b and 22b are closed off by other heat sealed sheets of thermoplastic polyurethane.

FIG. 11 illustrates yet another embodiment variant similar to that shown in FIG. 10. The second portion 12c is once more an inflatable element with arms 21c and 22c that are produced by a succession of beads forming a V-shaped structure intended to receive the first portion 11 of the pelvis support. Such a bead-shaped structure is easily produced by heat sealing the internal walls.

FIG. 12 schematically illustrates another embodiment variant of a support device 31 for a human body 2 in a prone position.

This device 31 differs from the device 1 of FIG. 1 in terms of the pelvis support module 5. According to this embodiment variant, there is no second portion of this support module. Such an embodiment variant is more particularly suited to the case of a human body with a small build, for which the pelvis support module 5 is made up of the single first portion 11, which constitutes a sufficient volume to avoid contact between the abdomen and the bed and to enable the patient to breathe correctly in a prone position.

Tests have been performed with a device 1 in accordance with that shown in FIG. 1.

The human body 2 put in place on the four support modules has a mass of 90 kg.

Before the placement of the human body, the first portions 7, 9 and 11 of the head support module 3, shoulder support module 4, pelvis support module 5 and leg support module 6 are partially filled with inflation gas so as to detach the walls of the pneumatic cavities.

The human body 2 is put in place on the support modules and each of the pneumatic elements mentioned above is brought to and kept at the desired support pressure.

The determined pressures in this scenario for providing optimum support that make it possible to reduce the risks of bedsores appearing and ensure pneumatic support are as follows.

The pressures are given in the following table for each of the support modules:

| | Pressure (bar) |
|---|---|
| First portion 7 of the head support module 3 | 0.014 |
| First portion 9 of the shoulder support module 4 | 0.033 |
| First portion 11 of the pelvis support module 5 | 0.054 |
| Leg support module 6 | 0.024 |

1.-15. (canceled)

16. A device (1) for supporting a human body (2) in a lying-down position, the device comprising at least one shoulder support module (4) and at least one pelvis support module (5),
wherein the at least one shoulder support module (4) and the at least one pelvis support module (5) are made up of at least one first portion (9, 11) that comes into contact with the human body (2),
wherein the at least one first portion (9, 11) each forms a pneumatic cavity,
wherein the at least one first portion (9, 11) has a valve, and
wherein the at least one first portion (9) of at least one shoulder support module (4) is kept at a pressure of less than 0.04 bar underneath a weight of the human body (2).

17. The device (1) for supporting a human body (2) in a lying-down position according to claim 16, wherein the at least one shoulder support module (4) has an asymmetry between a portion oriented toward a lower body and a portion oriented toward a head so as to optimize support of fixed parts of the human body surrounding a thorax during breathing.

18. The device (1) for supporting a human body (2) in a lying-down position according to claim 16, wherein the device has at least one head support module (3),
wherein the at least one head support module (3) is made up of at least one first portion (7) that comes into contact with the human body (2),
wherein the at least one first portion (7) of the at least one head support module (3) forms a pneumatic cavity,
wherein the at least one first portion (7) of the at least one head support module (3) has a valve, and
wherein at least the first portion (7) of the at least one head support module (3) is kept at a pressure of less than 0.04 bar underneath the weight of the human body (2).

19. The device (1) for supporting a human body (2) in a lying-down position according to claim 18, wherein the at least one head support module (3) supports a lateral side of the head.

20. The device (1) for supporting a human body (2) in a lying-down position according to claim 19, wherein the at least one head support module (3) is profiled to act as a bearing point for one side of the head, and
wherein a cutout (13) is provided so as to leave an ear accessible.

21. The device (1) for supporting a human body (2) in a lying-down position according to claim 16, wherein the device has at least one leg support module (6),
wherein the at least one leg support module (6) is made up of at least one first portion that comes into contact with the human body (2),
wherein the at least one first portion of the at least one leg support module (6) forms a pneumatic cavity,
wherein the at least one first portion of the at least one leg support module (6) has a valve, and
wherein at least the first portion is kept at a pressure of less than 0.04 bar underneath the weight of the human body (2).

22. The device (1) for supporting a human body (2) in a lying-down position according to claim 16, wherein the at least one first portions (9, 11) of at least one support module for a part of the human body (2) are made up of at least one sheet of thermoplastic polymer.

23. The device (1) for supporting a human body (2) in a lying-down position according to claim 16, wherein at least areas of the at least one first portion (9, 11) of at least one support module for a part of the human body (2) that are intended to come into contact with skin are covered with a medical fabric.

24. The device (1) for supporting a human body (2) in a lying-down position according to claim 16, wherein at least one support module for a part of the human body (2) has a second portion (8, 10, 12) supporting the at least one first portion (9, 11).

25. The device (1) for supporting a human body (2) in a lying-down position according to claim 24, wherein the second portion (8, 10, 12) of at least one support module for a part of the human body (2) is made up of multiple stackable elements.

26. The device (1) for supporting a human body (2) in a lying-down position according to claim 24, wherein the second portion (8, 10, 12) of at least one support module for a part of the human body (2) is at least partially made up of a polymer foam with a compressive stiffness of between 5 KPa and 50 KPa.

27. The device (1) for supporting a human body (2) in a lying-down position according to claim 24, wherein the second portion (8, 10, 12) of at least one support module for a part of the human body (2) is at least partially made up of a cavity,
wherein the second portion (8, 10, 12) of at least one support module for a part of the human body (2) has a valve, and
wherein the second portion (8, 10, 12) of at least one support module for a part of the human body (2) is kept at a pressure of between 0.05 and 1 bar underneath the weight of the human body (2).

28. The device (1) for supporting a human body (2) in a lying-down position according to claim 16, wherein the human body (2) is in a prone position.

29. A method for supporting a human body (2) implementing the device according to claim 16, the method comprising:
in a first step, partially filling the cavity of at least one first portion of at least one support module for a part of the human body (2) with air;
in a second step, disposing the human body on the at least one support module for a part of the human body; and
in a third step, regulating a pressure of the cavity of at least one first portion of at least one support module for a part of the human body to a pressure less than 0.04 bar.

30. The method for supporting a human body (2) according to claim 29, wherein the at least one support module for the human body (2) has a second portion supporting a first portion of the support module for the human body (2) and at least partially forms a pneumatic cavity, further comprising a fourth step of regulating a pressure of the cavity of the second portion of the support module for the human body (2) to a pressure of between 0.05 and 1 bar.
